(19) United States
(12) Patent Application Publication
(10) Pub. No.: US 2026/0252813 A1
(43) Pub. Date: Aug. 27, 2026

(54) DETECTING NATURAL LANGUAGE PROCESSING (NLP) DRIFT USING FOCUSED-LANGUAGE EXPANSION

(71) Applicant: INTERNATIONAL BUSINESS MACHINES CORPORATION, Armonk, NY (US)

(72) Inventors: Erika Agostinelli, Bristol (GB); Edward James Biddle, Winchester (GB); Stefan A. G. Van Der Stockt, Austin, TX (US); Sourav Mazumder, Contra Costa, CA (US)

(21) Appl. No.: 19/062,569

(22) Filed: Feb. 25, 2025

(51) Int. Cl. G06F 40/40; G06F 40/247; G06F 40/253; G06F 40/284; G06F 40/30

(52) U.S. Cl. CPC G06F 40/40; G06F 40/247; G06F 40/253; G06F 40/284; G06F 40/30

(57) ABSTRACT

Detection of natural language data drift includes training an enriched language model using on an expanded ground truth. The enriched language model is trained to perform natural language processing (NLP) using a natural language vocabulary converted to embeddings comprising vectorial representations within an Enriched Embedding Space (EES). The enriched language model generates an enriched language model embedding in response to a user input, the enriched language model embedding comprising a vectorial representation of the user input within the EES. A distance between the enriched language model embedding and a nearest embedding within the EES is computed. Whether the enriched language model is affected by drift is determined based on the distance. Responsive to detecting the enriched language model is affected by drift, the type of the drift is determined.

### BACKGROUND

This disclosure relates to natural language processing (NLP) and, more particularly, to detecting data drift affecting a trained NLP model.

An NLP model, as with many types of machine learning models, may be afflicted post-training by data drift. Data drift occurs when data that has been used to train an NLP model no longer adequately represents the data that is received for processing by the NLP model at runtime in the field. Although data drift can affect virtually all types of machine learning, drift may be especially pernicious with respect to NLP models given the ever-evolving nature of language. Word meanings may change with time and new words may emerge due to newly introduced technologies or changes in culture, for example. As a result, the accuracy and relevancy of an NLP model can be adversely affected if drift afflicting the model is not detected and corrected.

### SUMMARY

In one or more embodiments, a method of detecting natural language data drift includes training an enriched language model using on an expanded ground truth. The enriched language model is trained to perform natural language processing (NLP) using a natural language vocabulary converted to embeddings comprising vectorial representations within an Enriched Embedding Space (EES). The enriched language model generates an enriched language model embedding in response to a user input, the enriched language model embedding comprising a vectorial representation of the user input within the EES. A distance between the enriched language model embedding and a nearest embedding within the EES is computed. Whether the enriched language model is affected by drift is determined based on the distance. Responsive to detecting the enriched language model is affected by drift, the type of the drift is determined.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings.

FIG. 1 illustrates an example of a computing environment that is capable of implementing a drift detection and correction (DDC) framework.

FIG. 2 illustrates an example architecture of the DDC framework of FIG. 2.

FIG. 3 illustrates an example method of operation of the DDC framework of FIG. 2.

FIG. 4 illustrates certain operative features of the DDC framework of FIG. 2.

FIG. 5 illustrates certain other operative features of the DDC framework of FIG. 2.

FIG. 6 illustrates still other operative features of the DDC framework of FIG. 2.

FIG. 7 illustrates yet other operative features of the DDC framework of FIG. 2.

FIG. 8 illustrates certain other operative features of the DDC framework of FIG. 2.

### DETAILED DESCRIPTION

While this disclosure concludes with claims defining novel features, it is believed that the various features described herein will be better understood from consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to natural language processing (NLP) and, more particularly, to detecting data drift affecting a trained NLP model. Of the different types of drift affecting machine learning models, there are few techniques that identify or correct input, or covariate, drift affecting NLP models. Conventional techniques are limited in several significant ways. For example, conventional techniques typically rely on a generalized vocabulary that is derived from a very broad language corpus. Many conventional techniques impose heavy computational burdens and are thus expensive to execute. If performed incorrectly, attempts at dimensionality reduction too often result in unreliable drift detection. Moreover, conventional techniques provide little, or usually none, of the computational nuance necessary to distinguish between different types of input (covariate) drift.

In accordance with the inventive arrangements described herein, methods, systems, and computer program products are provided that are capable not only of identifying both domain and in-domain drift but distinguishing one type from the other. The inventive arrangements, moreover, are capable of distinguishing between domain and in-domain drift even if both domain and in-domain drift affect the same NLP model.

An aspect of the inventive arrangements is an enhanced language model. The enhanced language model is an NLP model concentrated on a vocabulary specific to a given domain. As used herein, “domain” means a vocabulary of words drawn from a specific topic or subject matter. The vocabulary is characterized by a domain-specific lexicon. For example, the domain-specific lexicon of the medical domain includes words such “cardiovascular” and “neuropathy,” whereas the domain-specific lexicon of the financial domain includes words such as “investment” and phrases such as “stock market.”

The inventive arrangements create an enriched language model, an NLP model that is trained on an expanded ground truth. The inventive arrangements create the expanded ground truth by expanding a domain-specific ground truth using all or a combination of processes. The processes broaden the vocabulary of the domain-specific ground truth by adding word embeddings that were not originally encompassed within the ground truth but nonetheless are semantically relevant to the specific domain. Using the enriched language model trained on the expanded ground truth, the inventive arrangements generate an enriched embedding space.

The enriched embedding space of the inventive arrangements is capable of detecting data drift affecting the language model and distinguishing between domain drift and in-domain drift. Moreover, the detecting drift and distinguishing between the types of drift may be done at runtime as the NLP model is processing live transactions. Domain drift is induced by a shift in language input to the NLP model that adversely affects the model's performance. In-domain drift by contrast encompasses valid language variations within a specific domain. There is thus a high probability, though not a certainty, that language input to the NLP model is merely a variant of a topic or subject matter for which the model is trained. The ability of the inventive arrangements to detect and distinguish the different types of drift provides distinct technical advantages, including dictating different measures to correct drift. In-domain drift does not necessitate retraining of the model, which is typically costly and time consuming. Distinguishing domain drift from in-domain drift may avoid unnecessary retraining of the model. Another advantage is that recognizing word embeddings characterized by in-domain drift enables updating the embedding space of the model with the very same word embeddings, which can keep the model up to date on a real-, or near real-time, basis and without retraining.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the inventive arrangement are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

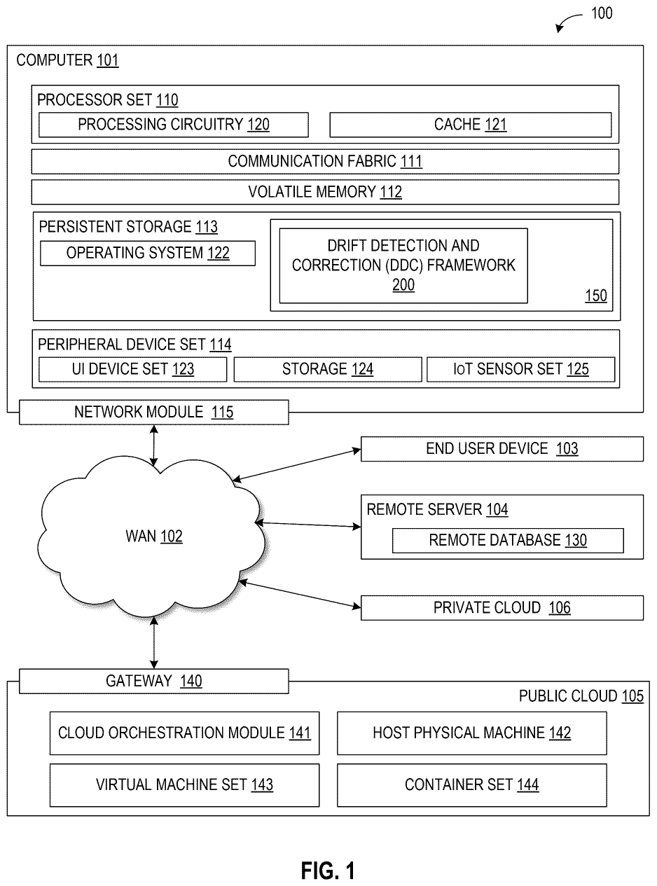

Referring to FIG. 1, computing environment 100 contains an example of an environment for the execution of at least some of the computer code illustrated at block 150 that is involved in performing the inventive methods disclosed herein. The inventive methods performed with the computer code of block 150 can include implementing a drift detection and correction (DDC) framework 200 capable of detecting drift affecting a trained NLP model, distinguishing between in-domain and domain covariate drift, and taking action based on the type of drift to mitigate or eliminate the drift.

DDC framework 200 is capable of expanding a ground truth used to train a NLP model. Using the expanded ground truth, an enhanced language model is trained that is capable of generating an enhanced embedding space. The embedding space comprises vectorial representation of words and may be used to detect natural language drift and, if drift is detected, to detect the type of drift (e.g., differentiate between different types of drift). Based on the type of drift identified, a proper course of action to correct the drift is initiated.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

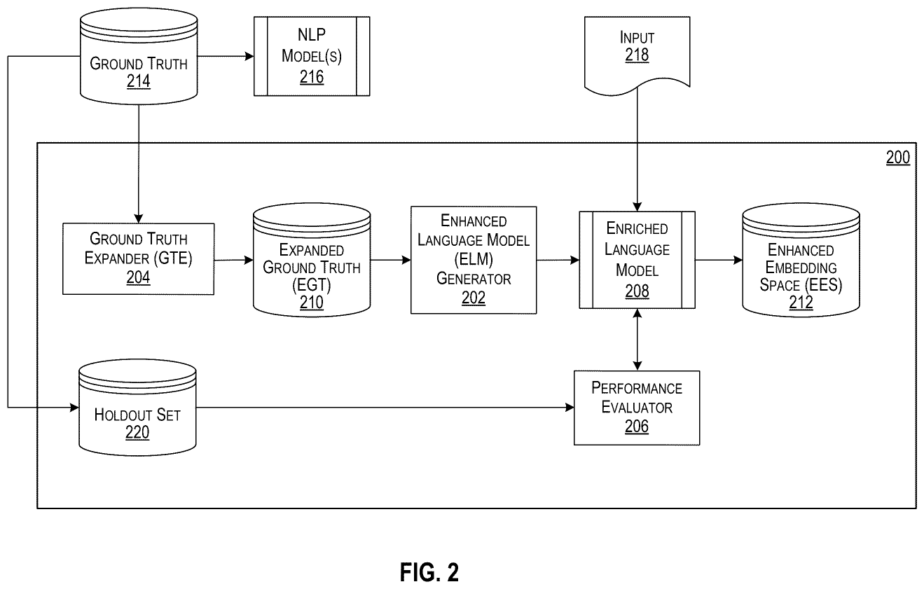

FIG. 2 illustrates an example architecture of DDC framework 200. In the example architecture of FIG. 2, DDC framework 200 illustratively includes enhanced language model (ELM) generator 202, ground truth expander (GTE) 204, and performance evaluator 206. enhanced language model generator 202, ground truth expander 204, and performance evaluator 206 of DDC framework 200, in certain embodiments, are implemented in software that executes on the hardware of computer 101 operating in computing environment 100. Operatively, DDC framework 200 is capable of determining whether a ground truth (training examples or embeddings) used for training an NLP model is likely affected by data drift, and if the NLP model is affected, then the type of drift that is likely affecting the NLP model.

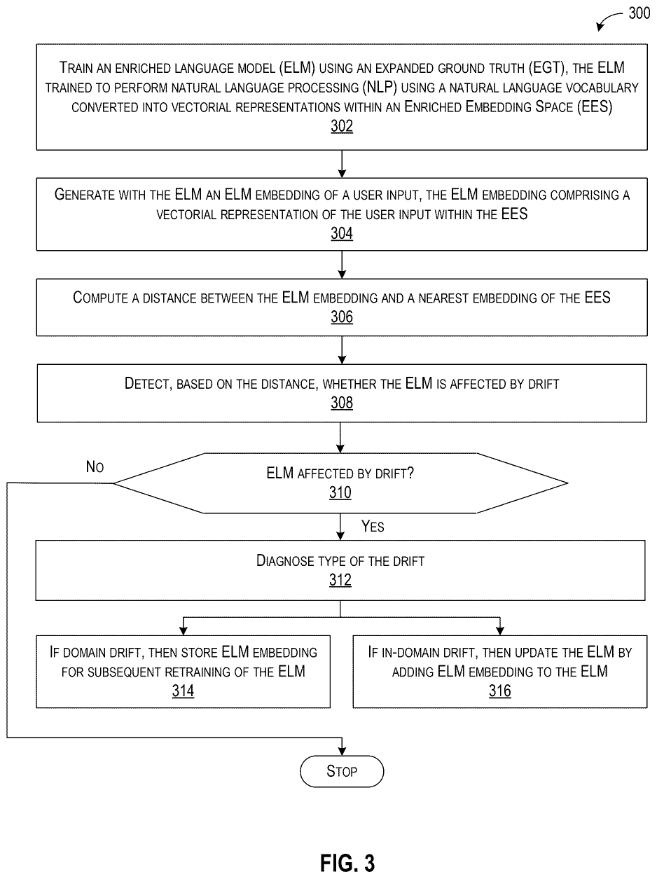

FIG. 3 illustrates an example method 300 of operation of DDC framework 200 of FIG. 2. Referring to FIGS. 2 and 3 collectively, in block 302, enhanced language model generator 202 trains an enriched language model (ELM) 208 using an expanded ground truth (EGT) 210 generated by ground truth expander 204. Enriched language model 208 is trained to perform natural language processing (NLP). The NLP, depending on the nature of training, may include various tasks such as understanding and responding to user queries, performing speech recognition, converting text to speech, classifying text, or performing machine translations from one language to another. The enriched language model 208 is trained to perform NLP using a natural language vocabulary converted to vectorial representations (embeddings) within enriched embedding space (EES) 212.

Ground truth expander 204 generates expanded ground truth 210 by expanding ground truth 214. Ground truth 214 is data comprising verified, correctly annotated examples that are used for training, validating, and testing one or more other NLP models 216. Accordingly, in some applications, DDC framework 200 in performing the operations described herein also may be used to determine whether NLP model(s) 216 may be affected by data drift by having been trained on ground truth 214. Ground truth expander 204, in various embodiments, generates the expanded ground truth 210 by expanding ground truth 214 using one or more various techniques. In certain embodiments, the techniques applied by ground truth expander 204 include parsing of both synonyms and antonyms using a machine learning model such as a deep learning neural network (e.g., transformer) trained to capture word relationships between words in large corpora. The machine learning model may be trained on a corpus to recognize word patterns and/or relationships between words.

The machine learning model(s) implemented by ground truth expander 204 to expand ground truth 214 may be trained through supervised learning using labeled datasets containing pairs of synonyms and/or antonyms. Using word embeddings that represent words in a continuous vector space, the machine learning model may recognize antonyms as pairs of opposing vectors and synonyms as the same or closely aligned vectors. Ground truth expander 204, in some embodiments, may additionally or alternatively implement one or more sequence-to-sequence models having attention mechanisms and trained to generate paired text in which the respective texts comprise different words that have the same meaning. In still other embodiments, ground truth expander 204 may implement one or more text-to-text transfer transformers to perform word paraphrasing. Ground truth expander 204 in yet other embodiments may implement a neural network having attention mechanisms and being trained to rearrange words or phrases to generate grammatically reordered text.

Ground truth expander 204, in some embodiments, may implement language intent modifiers incorporated into one or more machine learning languages to vary the meaning of sentences by varying pronouns and/or adverbs. Different perturbations within the boundary of predetermined grammatical rules may be generated by the machine learning model(s). Implementing other natural language understanding (NLU) models, ground truth expander 204 may expand ground truth 214 using keyword and/or concept generalization with contextual ontologies to expand the ground truth. Hyponymy expansion, in certain embodiments, leverages semantic relations to expand target words and hypernymy expansion provides a hierarchical structure by associating general words (e.g., hypernym “dog”) for specific ones (e.g., hyponym “poodle”). Morphological and stemming expansion and contraction may be implemented by ground truth expander 204 to link words and phrases that differ only as to the complexity of their respective forms (e.g., “does not” and “doesn't”). Ground truth expander 204, in still other embodiments, may implement lexical semantic variation to identify polysemous and synonymous words. In some embodiments, ground truth expander 204 may expand ground truth 214 using machine-generated synthetic text.

Implementing all or various combinations of the above-described techniques, ground truth expander 204 generates expanded ground truth 210 by expanding ground truth 214 to include embeddings that are variants of those of the original ground truth while adding new embeddings that are sufficiently related to those of the original ground truth as to be correctly included in the same domain as the original ground truth. Enhanced language model generator 202 trains enriched language model 208 using expanded ground truth 210 generated by ground truth expander 204. The richer, expanded dataset comprising expanded ground truth 210 enables enriched language model 208 to transform a more limited embedding space formed from ground truth 214 into EES 212.

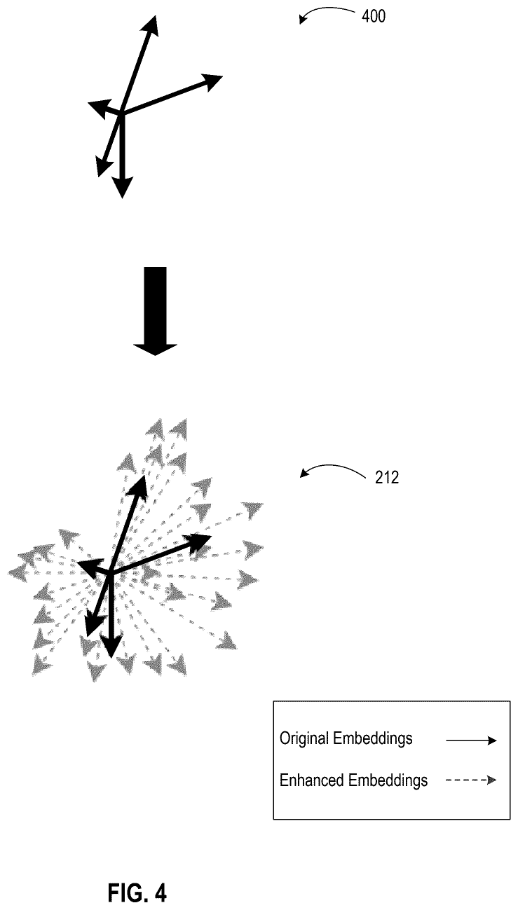

Referring to FIG. 4 in addition to FIGS. 2 and 3, a schematic representation of embedding space 400 formed by ground truth 214 is compared to that of EES 212. EES 212 is created by enriched language model 208, which is trained using expanded ground truth 210 to convert natural language into embeddings (vectorial representations). EES 212, as shown in FIG. 4, is a vector space that is composed of both the original embeddings of embedding space 400 and the enhanced embeddings used to expand the space into expanded ground truth 210. As illustrated by the comparison, EES 212 provides a considerable larger array of vectorial representations (embeddings). The enhanced array of embeddings of EES 212 are used not only to detect whether enriched language model 208 or other NLP model(s) 216 are affected by data drift but also to determine the type of drift if the model is affected. The type of drift affecting the NLP model dictates the proper remedy for ameliorating the drift.

Referring still to FIGS. 2 and 3 collectively, in block 304, enriched language model 208 generates an ELM embedding in response to input 218 of a user. The enriched language model embedding that is generated is a vectorial representation of input 218. In block 306, performance evaluator 206 computes a distance, d, between the ELM embedding and the nearest original vectorial representation within EES 212. Performance evaluator 206, in various embodiments, computes the distance using various metrics. The metrics may include, for example, cosine difference, cosine similarity, Jaccard similarity, Manhattan distance, Euclidean distance, or comparable metric. The distance, d, between the ELM embedding and the nearest original vectorial representation within EES 212 is used by performance evaluator 206 to determine whether enriched language model 208 is affected by data drift, and if so, the type of drift.

In certain embodiments, performance evaluator 206 compares the computed distance, d, between the ELM embedding and the nearest original vectorial representation within EES 212 to a pair of predetermined thresholds, α and β, where α<β. Based on the comparison, performance evaluator 206 determines whether enriched language model 208 is affected by data drift and, if so, the type of drift. If the dual thresholds are used and if d<α, then no drift is detected. That is, enriched language model 208 can generate the NLP prediction or perform the NLP task based on, or in response to, input 218 with acceptable accuracy. If α≤d≤β, then there is drift and a region of embedding space 400 surrounding (e.g., region within multi-dimensional sphere with radius β) the ELM embedding is searched. If one or more enhanced embedding lies within the region, then the region is “dense,” and the drift is categorized by performance evaluator 206 as in-domain drift. In-domain drift means the enhancement of enriched language model 208 enables the model to generate an NLP prediction or perform the NLP task, but the prediction may not be reliable, or the task may not be performed correctly. If no enhanced embedding lies within the region of embedding space 400 surrounding the ELM embedding, the region is “sparse,” and the drift is categorized by performance evaluator 206 as domain drift. If d>β, then enriched language model 208 is affected by data drift and is unable to generate the NLP prediction or perform the NLP task based on, or in response to, input 218.

In certain embodiments of DDC framework 200, the distance metric and thresholds for determining whether enriched language model 208 is affected by data drift are user-selected parameters. A user may set one or more thresholds based on the average, median, or other statistical measure of distances between the vectorial representations of embeddings in EES 212. For example, the user may select cosine distance as the metric for measuring d and select the median of the cosine distances to use in setting the thresholds α and β. DDC framework 200 automatically computes cosine distances between pairs of embeddings and the median of all the cosine distances. If, for example, the median cosine distance is 0.5, then the user may set α=0.5 and β=0.8. Threshold values may vary according to the distance metric selected by the user and the level of confidence in the accuracy of enriched language model 208 that the user prefers. For example, cosine distance (one minus cosine similarity) measures the dissimilarity between embeddings. The smaller the thresholds, the more accurate DDC framework 200's determination of whether enriched language model 208 is affected by drift is likely to be.

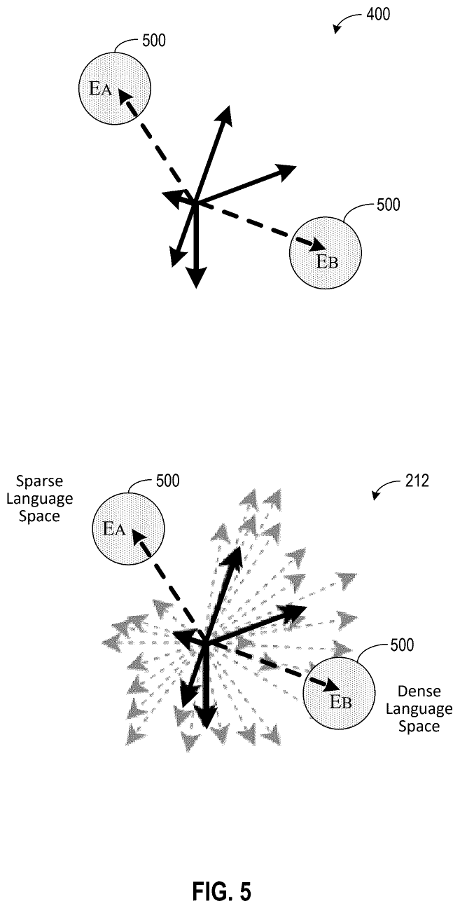

In other embodiments, the user may select a single threshold for determining whether enriched language model 208 is affected by data drift without regard to the type of drift (in-domain or domain drift). Referring now to FIG. 5 in addition to FIGS. 2 and 3, the determination of data drift by DDC framework 200 using a single threshold is illustrated. The threshold is the radius of sphere 500 extending around example embeddings E_{A} and E_{B}, both generated by enriched language model 208 in response to a user input. Although appearing only as a circle, sphere 500 is more likely a high-dimensional sphere given that in virtually all applications EES 212 has vastly more than two or three dimensions. Within EES 212, E_{A} is not sufficiently close to any vectorial representations of the embeddings in EES 212, thus indicating domain drift. E_{B}, however, is within the threshold established by sphere 500 relative to certain of the enhanced embeddings of EES 212. By comparison, neither E_{A} nor E_{B} are within the threshold relative to any of the original embeddings of embedding space 400 formed by ground truth 214, which is indicative of domain drift affecting an NLP model trained on ground truth 214. The comparison illustrates a significant technical advantage of DDC framework 200. EES 212 created by enriched language model 208 includes the enhanced embeddings that are lacking in embedding space 400. The enhanced embeddings are the result of training enriched language model 208 on expanded ground truth 210, which expands ground truth 214 to include variants of the topic or subject matter of ground truth 214. The closeness of E_{B} to one or more enhanced embeddings of EES 212 indicates that E_{B} is not, in fact, out of domain but merely a variant of the topic or subject matter. That is, the drift with respect to E_{B} is in-domain drift. Without the enhanced embeddings of enriched language model 208 an NLP model trained only on ground truth 214 mistakenly treats both E_{A} and E_{B} as out-of-domain embeddings and indicative of domain drift. The misdiagnosis may lead to unnecessary retraining, which is typically costly and almost invariably time consuming.

Referring still to FIGS. 2 and 3 collectively, in block 308 performance evaluator 206 detects whether enriched language model 208 is affected by drift based on the distance between the enriched language model embedding and the nearest embedding within EES 212. Drift is detected if the distance is greater than a predetermined threshold. In decision block 310, if performance evaluator 206 detects drift, then performance evaluator diagnoses the type of drift (domain or in-domain) in block 312. In certain embodiments, the type of drift is determined to be in-domain drift if the distance between the ELM embedding and the nearest embedding within EES 212 is within an interval bounded by a pair of thresholds comprising, respectively, a lower bound, α, and an upper bound, β. The drift is determined to be domain drift if the distance is greater than the upper bound of the threshold.

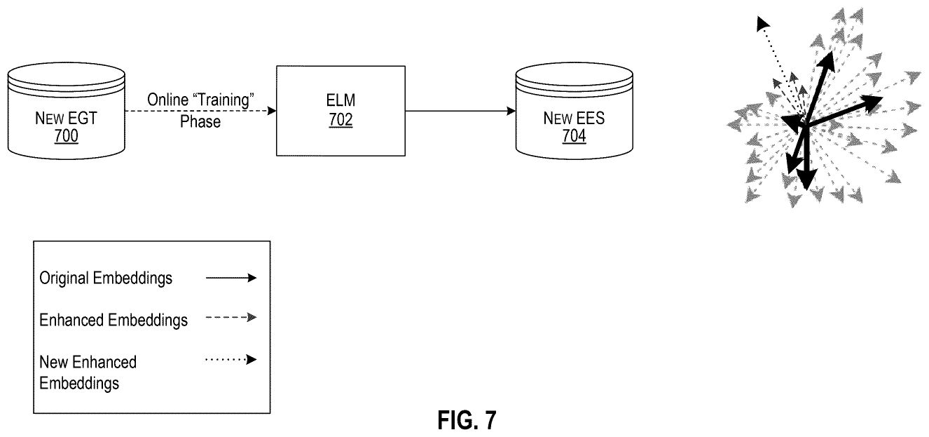

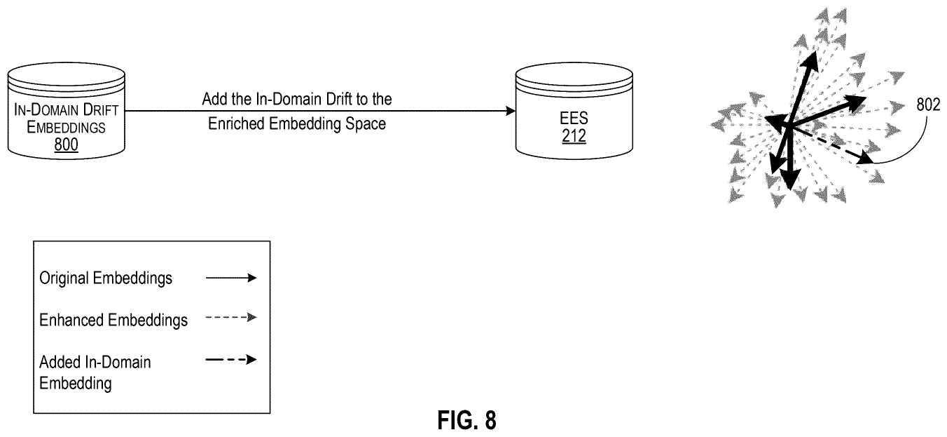

In certain embodiments, in response to detecting that enriched language model 208 is affected by drift, DDC framework 200 initiates action to alleviate the drift. The action initiated by DDC framework 200 depends on the type of drift detected. If enriched language model 208 is affected by domain drift, then at block 314 the ELM embedding is stored for subsequently retraining the model. In certain embodiments, DDC framework 200 implements the procedures described below with reference to FIG. 7 for retraining enriched language model 208. If the detected drift is in-domain drift, then at block 316 the ELM embedding is added to EES 212, which updates the EES accordingly. The procedures for updating EES 212 are described below with reference to FIG. 8. As described below with reference to FIGS. 7 and 8, the action of storing the ELM embedding if domain drift is detected, or alternatively, adding the ELM embedding to EES 212 if in-domain drift is detected can be performed during runtime execution in which multiple user inputs are processed as live transactions.

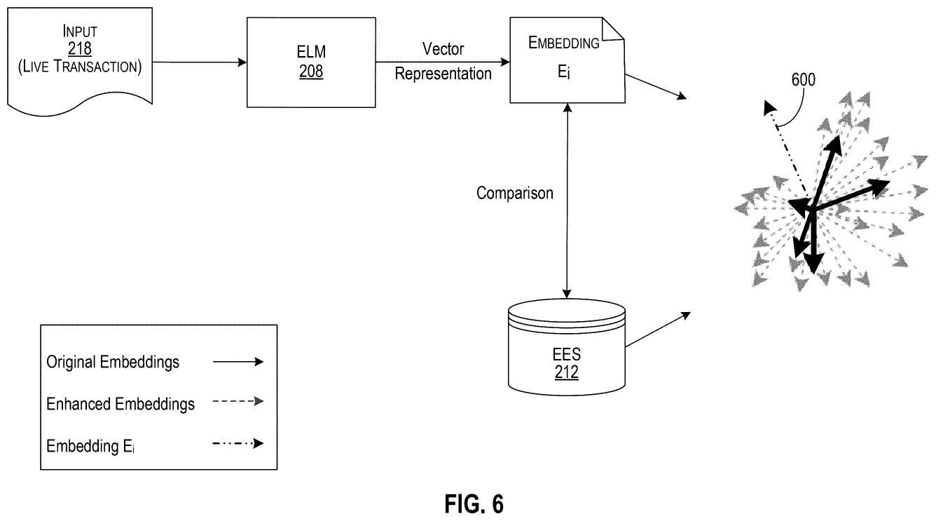

In certain embodiments, illustrated in FIG. 6, input 218 is a live transaction. That is, input 218 is a real-time interaction or exchange of information between a user and enriched language model 208. The interaction or exchange, for example, may include enriched language model 208's processing and responding to input 218, where the input involves one or more queries, commands, or other inputs occurring in real time. Enriched language model 208 having been trained to perform one or more NLP tasks in response to the live transaction outputs enriched language model embedding Eᵢ in response to input 218. Schematically, Eᵢ is represented by vectorial representation 600 within the enhanced embedding space generated by enriched language model 208. Performance evaluator 206 performs scoring of the live transaction by assigning a score for ELM embedding Eᵢ based on how accurate enriched language model 208's response to input 218 is. The distance between Eᵢ and the nearest enhanced embedding of EES 212 is the score. The score indicates whether enriched language model 208's response is accurate or is affected by drift, and if it is affected by drift, whether the drift is domain drift or in-domain drift as described above. If the score of a live transaction indicates domain drift, enriched language model 208 output may be rejected. For example, the output may be discarded and not provided to another system or end user device. An indication of the rejection may be output in place. The score indicates a high probability that the live transaction involves language for which the model is untrained. If the score of a live transaction indicates in-domain drift, the output of the model may not be rejected but may be automatically flagged to indicate uncertainty. That is, there is drift, but it is in-domain drift. The score indicates a high probability that the live transaction is merely a variation of language for the existing topic or subject matter on which the model is trained.

FIG. 7 illustrates retraining of enriched language model 208 implemented by DDC 200 using multiple scores. Live transactions scored as affected by domain drift are automatically stored during runtime for subsequent use in retraining the model. As such, the retraining is enhanced by the automated collection of data a real-world evolution of language. In certain embodiments, once the number of embeddings detected as domain drift-affected reaches a predetermined value, DDC 200 signals the need for retraining. For retraining, enriched language model embeddings automatically detected as domain drift-affected responses to live actions are added to ground truth 214, the original ground truth, to create a new ground truth. The new ground truth (which includes the domain drift-affected enriched language model embeddings) is expanded by ground truth expander 204 using all or a combination of the methods and procedures described above. Ground truth expander 204, accordingly, outputs a new expanded ground truth, new EGT 700, which is used by enhanced language model generator 202 to train new enhanced language model, ELM 702. ELM 702 generates a new, updated enhanced embedding space, new EES 704. ELM 702 having been retrained on the new expanded ground truth overcomes the domain drift that affected enriched language model 208.

FIG. 8 illustrates retaining enriched language model embeddings representing enriched language model 208 responses to live actions in which the embeddings are determined by DDC framework 200 to be affected by in-domain drift. That is, the drift is characterized as low language drift, which, at least in some instances, results from possible variations with the original ground truth 214. There is no need, therefore, to retrain enriched language model 208. Rather, each enriched language model embedding, such as enriched language model embedding 802, affected by in-domain drift is merely added into EES 212. The inclusion of in-domain drift embeddings 800 is not computationally intensive and may be performed “live” (in real time) or periodically (e.g., daily) to ensure that EES 212 is up to date at virtually all times. This illustrates another significant technical advantage of DDC framework 200 in that misdiagnosis of the in-domain embeddings as full-blown domain drift-affected embeddings would likely lead to an unnecessary retraining of the NLP trained solely on ground truth 214. The retraining is computationally burdensome and typically entails at least some downtime. DDC framework 200's ability to distinguish between domain drift and in-domain drift reduces significantly any likelihood of an unnecessary retraining of enriched language model 208. Moreover, DDC framework 200 provides a mechanism for real-time, or near continuous, updating of enriched language model 208 by merely adding embeddings identified as in-domain embeddings into EES 212, thereby enhancing the accuracy of enriched language model 208.

In various other embodiments, performance evaluator 206 serves the additional function of validating enriched language model 208 after initial training by enhanced language model generator 202. The validation is performed using holdout set 220, the set comprising samples held out of ground truth 214 and not used for training enriched language model 208 so that instead the samples may be used to validate the model post training. In some embodiments, performance evaluator 206 implements K-fold cross validation, a resampling procedure that evaluates the robustness and generalizability of enriched language model 208. Using K-fold cross validation, performance evaluator 206 splits ground truth 214 into k equal subsets or “folds” and inputs the folds to enhanced language model generator 202 to train the enriched language model 208 k times—once with each fold—and validates the model each time.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A computer-implemented method, comprising:
training an enriched language model using an expanded ground truth, wherein the enriched language model is trained to perform natural language processing (NLP) using a natural language vocabulary converted to embeddings comprising vectorial representations within an Enriched Embedding Space (EES);
generating with the enriched language model an enriched language model embedding in response to a user input, wherein the enriched language model embedding comprises a vectorial representation of the user input within the EES;
computing a distance between the enriched language model embedding and a nearest embedding within the EES;
detecting, based on the distance, whether the enriched language model is affected by drift; and
responsive to detecting the enriched language model is affected by drift, diagnosing a type of the drift.

2. The computer-implemented method of claim 1, further comprising:
responsive to detecting the enriched language model is affected by drift, initiating action to alleviate the drift, wherein the action depends on the type of the drift detected.

3. The computer-implemented method of claim 2, wherein the action comprises retraining the enriched language model in response to determining the type of drift is domain drift.

4. The computer-implemented method of claim 2, wherein the action comprises updating the EES by adding the enriched language model embedding thereto in response to determining the type of drift is in-domain drift.

5. The computer-implemented method of claim 4, wherein the adding is performed during runtime processing of multiple other user inputs comprising live transactions.

6. The computer-implemented method of claim 1, further comprising:
generating the expanded ground truth by expanding a predetermined ground truth for training an NLP model;
wherein the expanding is performed by applying at least one of synonym and antonym expansion, semantically related keyword expansion, grammatical reordering, lexical semantic variation, or synthetic text generation.

7. The computer-implemented method of claim 1, further comprising:
storing the enriched language model embedding in response to detecting that the enriched language model embedding is affected by domain drift;
wherein the storing is performed during runtime processing of multiple user inputs comprising live transactions; and
wherein the enriched language model embedding is stored with other enriched language model embeddings affected by domain drift for subsequently updating the expanded ground truth and retraining the enriched language model with the expanded ground truth as updated.

8. The computer-implemented method of claim 1, validating the enriched language model using holdout data extracted from a predetermined ground truth.

9. A computer system, comprising:
a processor set;
one or more computer-readable storage media; and
program instructions stored on the one or more computer-readable storage media to cause the processor set to perform operations comprising:
training an enriched language model using on an expanded ground truth, wherein the enriched language model is trained to perform natural language processing (NLP) using a natural language vocabulary converted to embeddings comprising vectorial representations within an Enriched Embedding Space (EES);
generating with the enriched language model an enriched language model embedding in response to a user input, wherein the enriched language model embedding comprises a vectorial representation of the user input within the EES;
computing a distance between the enriched language model embedding and a nearest embedding within the EES;
detecting, based on the distance, whether the enriched language model is affected by drift; and
responsive to detecting the enriched language model is affected by drift, diagnosing a type of the drift.

10. The computer system of claim 9, wherein the operations further comprise:
responsive to detecting the enriched language model is affected by drift, initiating action to alleviate the drift, wherein the action depends on the type of the drift detected.

11. The computer system of claim 10, wherein the action comprises retraining the enriched language model in response to determining the type of drift is domain drift.

12. The computer system of claim 10, wherein the action comprises updating the EES by adding the enriched language model embedding thereto in response to determining the type of drift is in-domain drift.

13. The computer system of claim 12, wherein the adding is performed during runtime processing of multiple other user inputs comprising live transactions.

14. The computer system of claim 9, wherein the operations further comprise:
generating the expanded ground truth by expanding a predetermined ground truth for training an NLP model;
wherein the expanding is performed by applying at least one of synonym and antonym expansion, semantically related keyword expansion, grammatical reordering, lexical semantic variation, or synthetic text generation.

15. The computer system of claim 9, further comprising:
storing the enriched language model embedding in response to detecting that the enriched language model embedding is affected by domain drift;
wherein the storing is performed during runtime processing of multiple user inputs comprising live transactions; and
wherein the enriched language model embedding is stored with other enriched language model embeddings affected by domain drift for subsequently updating the expanded ground truth and retraining the enriched language model with the expanded ground truth as updated.

16. A computer program product comprising:
one or more computer-readable storage media; and
program instructions stored on the one or more computer-readable storage media to perform operations comprising:
training an enriched language model using on an expanded ground truth, wherein the enriched language model is trained to perform natural language processing (NLP) using a natural language vocabulary converted to embeddings comprising vectorial representations within an Enriched Embedding Space (EES);
generating with the enriched language model an enriched language model embedding in response to a user input, wherein the enriched language model embedding comprises a vectorial representation of the user input within the EES;
computing a distance between the enriched language model embedding and a nearest embedding within the EES;
detecting, based on the distance, whether the enriched language model is affected by drift; and
responsive to detecting the enriched language model is affected by drift, diagnosing a type of the drift.

17. The computer program product of claim 16, wherein the operations further comprise:
responsive to detecting the enriched language model is affected by drift, initiating action to alleviate the drift, wherein the action depends on the type of the drift detected.

18. The computer program product of claim 17, wherein the action comprises retraining the enriched language model in response to determining the type of drift is domain drift.

19. The computer program product of claim 17, wherein the action comprises updating the EES by adding the enriched language model embedding thereto in response to determining the type of drift is in-domain drift.

20. The computer program product of claim 19, wherein the adding is performed during runtime processing of multiple other user inputs comprising live transactions.
